(19) United States
(12) Patent Application Publication
(10) Pub. No.: US 2025/0130171 A1
(43) Pub. Date: Apr. 24, 2025

(54) MULTIPLEX CARS MICROSCOPY DEVICE

(71) Applicants: Universite de Limoges, Limoges (FR); Centre National de la Recherche Scientifique, Paris (FR)

(72) Inventors: Tigran MANSURYAN, Limoges (FR); Mehdi MADI, Limoges (FR); Tanguy LUTTMANN, Limoges (FR); Aymen CHARGUI, Limoges (FR); Alessandro TONELLO, Limoges (FR); Vincent COUDERC, Verneuil Sur Vienne (FR)

(21) Appl. No.: 18/710,778

(22) PCT Filed: Oct. 21, 2022
(86) PCT No.: PCT/EP2022/079337

§ 371 Date: May 16, 2024

(30) Foreign Application Priority Data
Nov. 17, 2021 (FR) FR2112129

(51) Int. Cl. G01N 21/65; G02F 1/35

(52) U.S. Cl. CPC G01N 21/65; G02F 1/3513; G01N 2021/655; G01N 2201/0686

(57) ABSTRACT

Multiplex CARS microscopy device for analysing a sample (Ech) comprising: -a laser source (LS) suitable for emitting a primary beam (FP) having a first wavelength λ₁, in the form of pulses (IL1) with a power called the primary power; -an optical fibre (F) supporting fewer than ten modes, said pulses propagating through the optical fibre (F) in anomalous dispersion regime so as to generate, from the primary beam, an output beam (FSC) containing a plurality of second wavelengths forming a supercontinuum (SC), and said first wavelength λ₁, the second wavelengths being generated by non-linear conversion of the first wavelength λ; -an optical system (MO) suitable for focusing the output beam onto said sample, so as to generate an anti-Stokes beam (STK) via stimulated Raman scattering induced by at least one of the second wavelengths and the first wavelength λ₁ present in the output beam; -a photodetector (Det) suitable for detecting the anti-Stokes beam.

### TECHNICAL FIELD

The present invention relates to the field of multiplex CARS microscopy.

### PRIOR ART

Coherent anti-Stokes Raman scattering microscopy (CARS) is an analysis technique particularly used in the field of imaging and spectroscopy to identify and locate specific chemical species within a sample. A great advantage of this technique is that the samples do not need to be marked with dyes that are sometimes toxic and therefore it is possible to carry out in vivo studies. Compared to conventional Raman microscopy and confocal Raman microscopy, which are widely known and developed, CARS microscopy allows obtaining a signal of interest several orders of magnitude more intense, better eliminating annoying side effects, and separating the detected light from the illumination light more easily. Conventional confocal Raman spectroscopy requires a pinhole to obtain good spatial resolution, as well as a high-resolution spectrometer. On the other hand, CARS is a non-linear optical process (four-wave mixing process) that does not require a pinhole and has a spatial resolution which is at most one-third of the wavelength used.

In a stimulated Raman scattering process, an incident pulsation pump wave ω_{P} on a molecule is inelastically scattered at a so-called Stokes pulsation wave ω_{S} and a so-called Anti-Stokes pulsation wave ω_{AS}. The frequency difference between the generated waves and the pump wave depends on the molecular vibrational pulsation of the sample (with frequency Ω_{R}) so that ω_{P}−ω_{S}=ω_{AS}−ω_{P}=Ω_{R}. The frequency shift of Stokes and Anti-Stokes waves corresponds to a specific vibration frequency of a molecule from the fundamental level. CARS microscopy consists in forcing the excitation of a specific chemical bond by means of a frequency difference. FIG. 1A is a schematic diagram of the energy levels involved in a CARS process. The fundamental level is denoted GS, the higher state of excited electronic energy is denoted EE, and the excited vibrational level of the Raman mode, resonant with a resonance frequency Ω_{R}, is denoted Vib. Unlike the spontaneous process of inelastic Raman scattering, this non-linear optical process of stimulated Raman scattering is only possible by using two distinct waves denoted pump wave at ω_{P} and Stokes wave at ω_{S} and which satisfy ω_{P}−ω_{S}=Ω_{R}. These waves must overlap spatially and temporally. A four-wave mixing then occurs, which leads to the stimulated emission of an Anti-Stokes pulsation wave ω_{AS}=2ω_{P}−ω_{S}. This phenomenon is much more effective (this gain is about 10⁶) than the spontaneous Stokes Raman scattering process because the molecular vibration Vib is specifically forced to vibrate by means of a frequency difference ω_{P}−ω_{S}. It is also selective because it is possible to target the chemical bond of interest by adjusting the frequency difference ω_{P}−ω_{S}. As the two-photon absorption, CARS is a multiphoton process (it uses two photons from the pump at ω_{P} and one Stokes photon at ω_{S}) which is all the more likely as the optical fields are strong. Therefore, CARS generally requires the use of pulsed lasers and occurs more preferably at the focus of a microscope objective which is used to focus the pump and Stokes fields in the sample.

FIG. 1B shows an example of wide spectral band CARS microscopy device known from the prior art. “Wide spectral band CARS” (or multiplex CARS) means that the device allows probing the sample with a probe beam which is a supercontinuum, having a very large number (>20) of mutually distinct wavelengths. The device comprises a pulsed laser source LS emitting at the frequency ω_{P}. A portion of the radiation from the source LS is used to generate a supercontinuum from ω_{P}, for example in a multimode PCF optical fiber, so as to generate a Stokes beam FSo comprising a plurality of frequencies in order to probe different chemical bonds each characterized by a vibrational frequency with a specific frequency Ω_{R}.

“Generation of supercontinuum” means herein a method consisting in spectrally broadening an initial beam to obtain a power substantially homogeneously distributed over a range of wavelengths of about 1000 nm or more. For example, the supercontinuum is generated by one or more non-linear effects of the second order or third order, from the following non-exhaustive list: self-phase modulation, cross-phase modulation, stimulated Raman effect, parametric four-or three-wave mixing, modulation instability, soliton propagation, soliton self-shift. . . . A delay line DL takes a portion FPo of the radiation from the source LS in order to form the pump beam at ω_{P}. These two beams FPo and FSo are spatially recombined and synchronized using a splitter blade LS and two mirrors MR1, MR2, both being movable and orientable. They are then focused by a microscope objective MO onto a region of the sample Ech. The anti-Stokes beam STK generated by resonant stimulated Raman effect is collimated by another objective CL then detected by a photodetector Det (a CCD camera or photomultiplier tube) typically combined with a spectrometer to spatially separate the wavelengths of the anti-Stokes beam. In the depiction in FIG. 1B, the device of the prior art comprises several optional mirrors MR2, M1, M2 for compactness reasons. This device allows analyzing the Raman signature of a sample over a very wide spectral range. By modifying the position of the sample Ech with respect to the focal point of the beams FSo and FPo, for example via a piezoelectric sample holder SH, it is possible to three-dimensionally map the sample and thus reconstruct three-dimensional images.

This device in FIG. 1B is satisfactory. However, it requires the use of the delay line DL in order to temporally synchronize the pump beam FPo with the Stokes beam FSo. Indeed, in CARS microscopy, the fibers generating the supercontinuum are used in normal dispersion regime to induce a generation of wavelengths exceeding the pump wavelength

$${λ}_{p} = \frac{2 π c}{{ω}_{p}}$$

with c being the speed of light in vacuum. In a known manner, this complex non-linear conversion using the stimulated Raman effect strongly depletes the pump wavelength λₚ. The remaining power at λₚ is then no longer sufficient to generate the stimulated Raman effect in the sample. However, the use of a delay line allows avoiding that a part of the pump wave is depleted due to the use of an optical path different from that generating the supercontinuum. Therefore, a part of the pump wave is preserved from the distortions induced during the generation of the supercontinuum.

The use of this delay line is restrictive because it reduces the compactness of the device and complicates the use thereof. Indeed, the presence of a delay line requires precise alignment and synchronization between the pump beam FPo and the Stokes beam FSo at the sample.

The invention aims to overcome this drawback with a multiplex CARS microscopy device with a fiber used for generating the supercontinuum in abnormal dispersion regime in order not to completely deplete the initial pump pulse generating the supercontinuum.

### SUMMARY OF THE INVENTION:

For this purpose, the invention relates to a multiplex CARS microscopy device for analyzing a sample comprising:
a laser source adapted to emit a primary beam having a first wavelength λ₁ in the form of pulses (IL1) with a so-called primary power;
an optical fiber having less than ten modes, said pulses propagating in the optical fiber (F) in an abnormal dispersion regime to generate, from the primary beam, an output beam (FSC) having a plurality of second wavelengths forming a supercontinuum, and said first wavelength λ₁, the second wavelengths being generated by non-linear conversion of the first wavelength λ₁;
an optical system adapted to focus the output beam onto said sample, so as to generate an anti-Stokes beam by stimulated Raman effect induced by at least one of the second wavelengths and the first wavelength λ₁ present in the output beam;
a photodetector adapted to detect the anti-Stokes beam.

According to a preferred embodiment of the invention, the optical fiber is suitable so that a power of the output beam at the first wavelength λ₁ is higher than or equal to 10%, preferably 20%, of the primary power.

According to a preferred embodiment of the invention, the optical fiber is a single-mode fiber with a microstructured sheath.

According to a preferred embodiment of the invention, the optical fiber has a zero-dispersion wavelength λ_{ZDW,i} associated with each i-th mode, said first wavelength λ₁ being higher than all zero dispersion wavelengths λ_{ZDW,i} by at least 10 nm.

According to a preferred embodiment of the invention, the device comprises an amplifier arranged on the optical path of the output beam upstream of the sample and adapted to selectively amplify the power of the output beam at the first wavelength λ₁. Preferably, the amplifier comprises an amplifying fiber having a core doped with rare earth elements, said amplifying fiber being attached or welded or coupled to a downstream end of the optical fiber. Still preferably, the amplifying fiber is pumped by second wavelengths of the output beam which are lower than the first wavelength λ₁. Alternatively, the amplifying fiber is pumped by a portion (PB) of the primary beam.

According to a preferred embodiment of the invention, the non-linear conversion includes self-shifting the solitons generated by the propagation of each pulse within the optical fiber by Raman effect.

According to a preferred embodiment of the invention, the device comprises a so-called upstream spectral filter arranged on the optical path of the output beam upstream of the sample and adapted to spectrally filter wavelengths less than the first wavelength. Preferably, the device comprises a processor adapted to analyze frequency information of the anti-Stokes beam detected by the photodetector, the upstream spectral filter (SF) being controllable and adapted to further filter a spectral range of the output beam as a function of said frequency information.

According to a preferred embodiment of the invention, the device comprises a so-called downstream spectral filter arranged on the optical path of the anti-Stokes beam and adapted to filter the output beam co-propagating with the anti-Stokes beam. Preferably, the upstream filter is adapted to spectrally filter a range of wavelengths exceeding the first wavelength.

According to a preferred embodiment of the invention, the optical fiber is adapted to have an additional zero-dispersion wavelength for a fundamental mode of the optical fiber, said additional zero-dispersion wavelength being separated by more than 3500 cm−1 from the first wavelength λ₁.

The invention also relates to a multiplex CARS microscopy method for analyzing a sample (Ech) with a device comprising an optical fiber (F) having less than ten modes to analyze a sample (Ech), said method comprising the following steps:
generating a primary beam (FP) having a first wavelength λ₁ in the form of pulses (IL1) with a so-called primary power;
generating, from the primary beam, an output beam (FSC) having a plurality of second wavelengths forming a supercontinuum (SC), and said first wavelength λ₁, the second wavelengths being generated by non-linear conversion of the first wavelength λ₁ in the optical fiber (F), said pulses propagating in the optical fiber (F) in abnormal dispersion regime;
focusing the output beam onto said sample so as to generate an anti-Stokes beam (STK) by stimulated Raman effect induced by at least one of the second wavelengths and the first wavelength λ₁ present in the output beam;
detecting the anti-Stokes beam.

### BRIEF DESCRIPTION OF THE DRAWINGS:

Other features, details and advantages of the invention will become apparent on reading the description made with reference to the accompanying drawings, given by way of example and showing, respectively:

FIG. 1A, a diagrammatic view of the CARS energy process

FIG. 1B, a diagrammatic view of a multiplex CARS microscopy device of the prior art,

FIG. 2, a multiplex CARS microscopy device according to the invention,

FIG. 3, a multiplex CARS microscopy device according to an embodiment of the invention,

FIG. 4, a multiplex CARS microscopy device according to an embodiment of the invention,

FIG. 5A, a multiplex CARS microscopy device according to an embodiment of the invention,

FIG. 5B, a multiplex CARS microscopy device according to an embodiment of the invention,

FIG. 5C, the power spectral density of a pulse IL2 of the output beam FSC at the outlet of fiber F (curve C1) and after filtering by the filter SF (curve C2),

FIG. 6A, the time profile of several spectral components of a laser pulse IL2 at the outlet of fiber F, in an embodiment of the invention,

FIG. 6B, the time profile of a laser pulse at 1064 nm of about 1.5 ns and peak power of 10 kW during propagation thereof in a single-mode fiber of HI980 type with a silica core in a normal dispersion regime,

FIG. 7, the Raman shift Ω_{R} constructed from the spectrum of the anti-Stokes beam at ω_{AS}=Ω_{R}+ω₁ detected by the device of the invention for a paraffin sample.

In the drawings, unless otherwise indicated, the items are not to scale.

### DETAILED DESCRIPTION

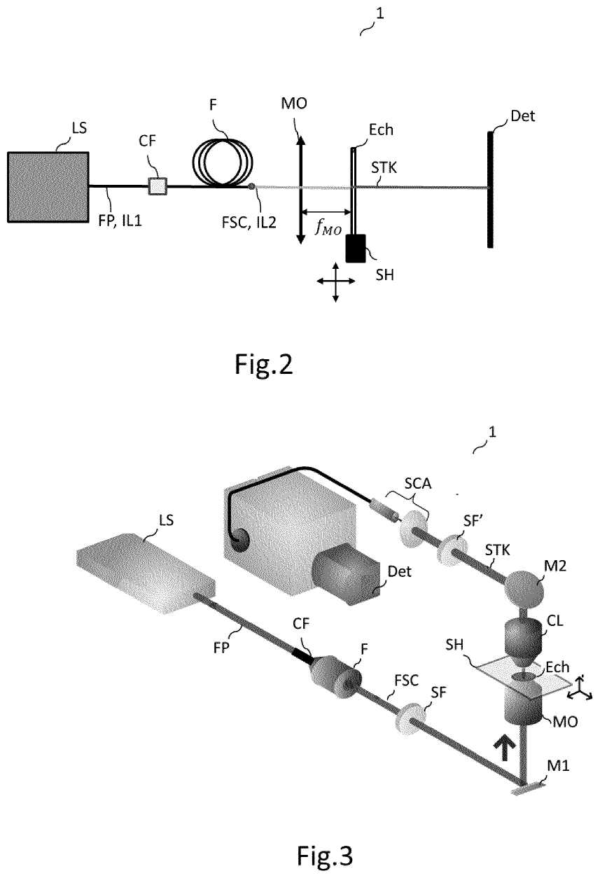

FIG. 2 diagrammatically shows a multiplex CARS microscopy device 1 according to the invention for analyzing a sample Ech.

The device 1 comprises a pulsed laser source LS adapted to emit a primary beam FP in the form of laser pulses IL1 with a so-called primary power and having a first wavelength

$${λ}_{1} = \frac{2 π c}{{ω}_{1}} ,$$

also referred to as pump wavelength, c being the speed of light in a vacuum. “Power of pulses” means herein a peak power. The laser pulses IL1 are nanosecond (ns), picosecond (ps), or femtosecond (fs) pulses. In the context of the present description, a nanosecond pulse is a pulse with a duration between 1 and 100 ns, a picosecond pulse is a pulse with a duration between 1 and 100 ps, and a femtosecond pulse is a pulse with a duration between 1 and 100 fs. For example, the frequency of the laser pulses is between 0.1 and 100 MHz. For example, the power of the laser pulses is between 5 kW and 10 MW. Considering the duration of laser pulses IL1, the first wavelength λ₁ should be considered as the central wavelength of the laser pulse IL1. Δω₁ is the spectral width of the pulses IL1.

According to one embodiment, the laser source LS is an optical fiber laser oscillator doped with a given material. For example, the doped optical fiber of the laser source LS is an optical fiber made of a given luminescent material (glass or glass matrix), doped with a material. The doping material is an optically active material, i.e., under excitement (for example by pump lasers inside the source LS) this material emits coherent light at a given wavelength.

According to one embodiment, the doping material is an ion, e.g., a rare earth ion. For example, the rare earth is neodymium (chemical symbol Nd), ytterbium (chemical symbol Yb), praseodymium (chemical symbol Pr), erbium (chemical symbol Er), thulium (chemical symbol Tm), holmium (chemical symbol Ho), or any other fluorescent element soluble in the glass matrix forming the fiber, such as bismuth (chemical symbol Bi). The first wavelength λ₁ depends on the doping material of the doped optical fiber of the laser source.

According to one embodiment, the laser source LS is a fiber laser oscillator of the phase mode-locked type. Such a locking of the longitudinal modes of the injection laser oscillator allows obtaining picosecond or femtosecond pulses. Other types of lasers, for example a “gain switch” type laser, also allows obtaining picosecond pulses.

The device 1 of the invention comprises an optical fiber F in which the pulses IL1 delivered by the source LS are injected, for example using an optical fiber coupler CF. The fiber F has fewer than ten spatial modes and has a zero-dispersion wavelength λ_{ZDW,i} associated with each mode i, the fundamental mode corresponding to i=0 herein. These wavelengths λ_{ZDW,i} are determined by numerical calculations as a function of the structure of the fiber and the materials forming the fiber F. For example, the fiber used is a single-mode step-index fiber such as HI980 fiber, or a solid core fiber with a microstructured sheath.

“Zero-dispersion wavelength λ_{ZDW,i}” of fiber F means the wavelength for which the dispersion of the group delay is zero for this spatial mode i.

In the description, the dispersion is said to be “abnormal” for any wavelength exceeding all the λ_{ZDW,i} propagating in the fiber F, and the dispersion is said to be “normal” for any wavelength less than all the λ_{ZDW,i} propagating in the fiber.

In particular, a wavelength control parameter λ_{ZDW,i} is the modal area of the fiber F. The smaller the modal area of the fiber F, the more the wavelengths λ_{ZDW,i} decrease. For a silica core fiber with a microstructured sheath, the diameter of the core will typically be 3-4 μm for a wavelength λ_{ZDW} at about 1000 nm for the fundamental mode.

In the invention, the pulses IL1 propagate in the optical fiber F in an abnormal dispersion regime, because the laser source LS and the fiber F are selected so that the first wavelength λ₁ of the pulses IL1 is higher than the wavelengths λ_{ZDW,i}. The optical fiber F is suitable for generating, from the primary beam FP, an output beam FSC having both the first wavelength λ₁ and a plurality of second wavelengths forming a supercontinuum SC, the second wavelengths being generated by non-linear conversion of the first wavelength λ₁. The output beam FSC has pulses IL2 formed from pulses IL1.

In a known manner, in abnormal dispersion regime and normal dispersion regime, the supercontinuum generation process on either side of λ₁ comprises the following phenomena: self-phase modulation, cross-phase modulation, parametric four-wave mixing, stimulated Raman effect.

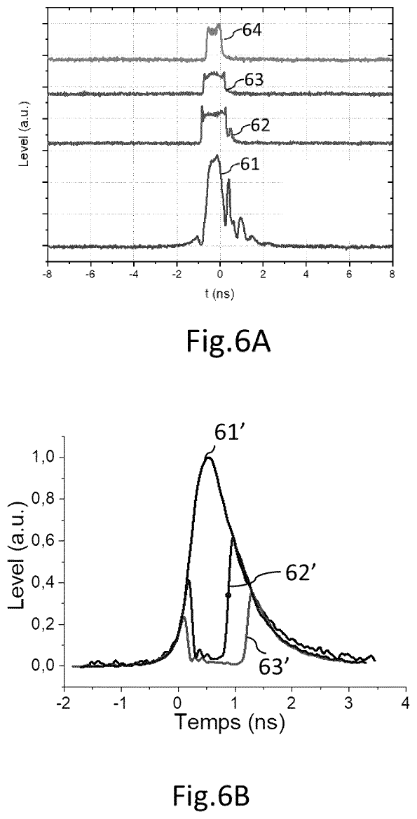

The inventors observed that, in an abnormal dispersion regime, the supercontinuum generation process depletes the pump wavelength much less significantly than in a normal dispersion regime (see in particular the description of FIGS. 6A and 6B below).

In the normal dispersion regime, in addition to the aforementioned phenomena, the stimulated Raman effect mechanism contributes very significantly to the depletion of the first wavelength λ₁ and the generation of the supercontinuum at wavelengths exceeding λ₁.

In the non-linear optical fiber of the invention, in abnormal dispersion regime, in addition to the aforementioned phenomena, a modulational instability occurs during the propagation of pulses IL1, which will temporally structure these pulses so as to create a plurality of solitons. These solitons will then self-shift by means of soliton self-shift by Raman effect (soliton self-frequency shift). This frequency shift is different for each soliton. The second wavelengths thus generated are strictly higher than the first wavelength λ₁ from which they are generated by stimulated Raman scattering, which is at the origin of the soliton self-frequency shift in the fiber. Stimulated Raman has a dissipative effect in terms of light energy. By virtue of the principle of total energy conservation, the second wavelengths cannot be lower than the initial wavelength λ₁. This self-shift phenomenon is predominant over other phenomena in an abnormal dispersion regime for the generation of second wavelengths exceeding λ₁.

In a known manner, the soliton self-shift by Raman effect causes a continuous drift of the central frequency of the soliton pulse by an energy exchange with the phonons of the medium forming the core of the optical fiber. Through this inelastic matter-light interaction, a photon of wavelength λₐ, i.e., of energy Eₐ=hc/λₐ, where h is the Planck constant, is absorbed by the physical medium. A second photon at a lower energy E_{b}<Eₐ is emitted by the Raman medium at a greater wavelength λ_{b}>λₐ. The energy difference, or quantum defect, is transmitted to the physical medium in the form of a particle corresponding to an acoustic vibration of the physical medium, or phonon. Note that Δv=c/λₐ−c/λ_{b}, the frequency shift between the two photons involved. During the interaction by Raman effect between the physical medium and an ultra-short pulse with wide frequency spectrum, the part of the pulse spectrum for Δv>0 is absorbed while the part of the pulse spectrum at Δv<0 is amplified. This corresponds to a sliding in the pulse spectrum towards low frequencies, i.e., a shift from the center of the pulse towards the high wavelengths.

This phenomenon of soliton self-shift by Raman effect is induced by the Raman gain for each soliton and therefore it does not completely deplete the pump after the initial fission of the pulse IL1 into solitons. This stimulated Raman process in the abnormal dispersion regime depletes the pump wave λ₁ much less than the stimulated Raman effect in the normal dispersion regime. Because of this, in the invention, the fiber, via the dispersion and length thereof, is adapted as a function of the power of the pulses IL1 so that a power of the output beam at the first wavelength λ₁ is non-negligible compared to the primary power of the pulses. More precisely, the fiber is short enough for the power of the output beam at the first wavelength λ₁ to be higher than or equal to 10%, preferably 20% of the primary power at the center of the pulse.

The soliton shift (therefore the second wavelengths λ₂) is a function of the length of fiber F, the dispersion, and the peak power of pulses entering the fiber F. The longer the fiber F, the more it is possible to obtain a significant frequency shift (and thus a wide supercontinuum). With as fixed fiber length, the higher the peak power of pulses, the more it is possible to obtain a significant frequency shift (and thus a wide supercontinuum). In the invention, for pulses of 1 ps and peak power of 135 kW, and for a silica core fiber with a microstructured sheath, the length of the fiber is of about 1 m.

In the invention, the optical fiber F has less than 10 modes because beyond that the intermodal interferences destroy the spatial profile of the beam which is no longer usable. Note then the creation of a speckle at the fiber outlet.

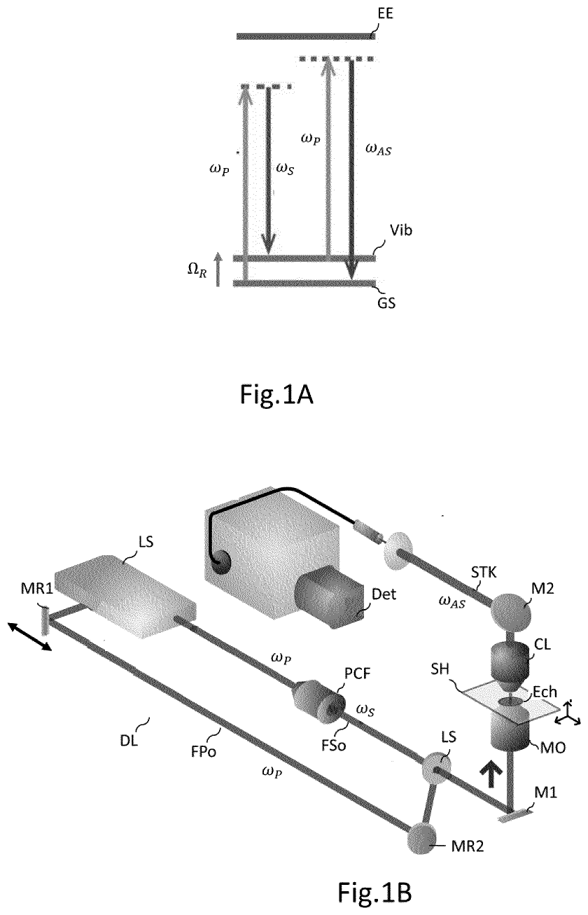

Unlike multiplex CARS devices of the prior art (see FIG. 1B), taking into account the non-negligible power of the output beam at the first wavelength λ₁, the device 1 of the invention does not require any delay line to synchronize a portion of the primary beam with the output beam on the sample. Due to the natural time synchronization between the second wavelengths and the first wavelength λ₁ at the outlet fiber F (see FIG. 6A), it is possible to only use the output beam to generate a stimulated Raman effect in the sample Ech. Thus, the device 1 comprises an optical system MO adapted to focus the output beam onto the sample. Preferably, the optical system MO is a microscope objective of focal length f_{MO}, preferably with a high numerical aperture (NA˜1.5). The output beam focused onto the sample generates an anti-Stokes beam STK by stimulated Raman effect induced by at least one of the second wavelengths exceeding λ₁ and the first wavelength λ₁ both present in the output beam FSC. The jϵ[1, N] second wavelengths λ_{2,j}=2π/ω_{2,j} of the beam FSC thus form the probe wavelengths. The photons of the beam FSC at the first wavelength λ₁ are in a sufficient number to induce the stimulated Raman effect in the sample Ech. Therefore, one or more vibrational levels of the resonant Raman modes of the sample Ech are excited at one or more resonance frequencies Ω_{R,j}=ω₁−ω_{2,j} and the anti-Stokes beam has one or more frequencies ω_{AS,j}=2ω₁−ω_{2,j}=Ω_{r,j}+ω₁. Therefore, the anti-stokes wavelengths λ_{AS,j}=2πc/ωA_{S,j} are lower than λ₁. In fact, in the device 1, the output beam FSC is both the pump beam (via the first wavelength λ₁) and the probe beam (via second wavelengths exceeding λ₁) of prior art devices.

The device comprises a photodetector Det known to those skilled in the art and adapted to detect the anti-Stokes beam, typically combined with a spectrometer in order to spatially separate the wavelengths of the anti-Stokes beam before being detected. The photodetector is typically a photomultiplier tube, a CCD camera, or an avalanche photodiode.

Due to the operation of fiber F in abnormal dispersion regime, the device of the invention does not use any delay line to transport the pump beam up to the sample in a synchronized manner with the probe beam in order to induce the multiplex stimulated Raman effect in the sample. This increases the compactness of the device and greatly simplifies the use thereof.

In the embodiment shown in FIG. 2, the anti-Stokes beam is collected “forwards” (F-CARS signal) by the photodetector. Preferably, in this embodiment, device 1 comprises a collection objective CL (Numerical aperture˜0.5) to collimate the anti-Stokes beam before being detected, thus allowing a large working distance (see FIGS. 3-5B).

Alternatively, according to another embodiment, the anti-Stokes beam is collected backwards (E-CARS signal) by the objective MO. In this embodiment, the device 1 then comprises a dichroic mirror to spatially separate the anti-Stokes beam and the output beam FSC incident on the sample before it can be detected with the photodetector Det.

Preferably, as shown in FIG. 2, the device 1 comprises a sample holder SH adapted to move the sample in the three-dimensional space, in order to three-dimensionally map the sample and thus reconstruct three-dimensional images.

According to a preferred embodiment of the invention, the first wavelength λ₁ is higher than all zero-dispersion wavelengths λ_{ZDW,i} by at least 10 nm in order to obtain a more significant progressive shift of the soliton pulses. This feature allows obtaining a wider spectrum in the output beam.

According to a preferred embodiment of the invention, the optical fiber is a single-mode fiber with a microstructured sheath, having a single zero-dispersion dispersion wavelength λ_{ZDW} and possibly having a core doped with rare earth elements. Using a single-mode fiber allows increasing the power density in the fiber core and obtaining greater spectral broadening for a given pump power.

FIG. 3 shows a diagrammatic perspective view of an embodiment of the device 1. In addition to the elements detailed in the description of FIG. 2, the device of the embodiment in FIG. 3 comprises a so-called upstream spectral filter SF arranged on the optical path of the output beam FSC upstream of the sample Ech and adapted to spectrally filter wavelengths less than the first wavelength. Preferably, the filter SF is adapted so that the filtered beam FSC comprises only the first wavelength and second wavelengths exceeding λ₁ useful for generating the anti-Stokes beam. This upstream filter SF allows identifying more easily the wavelengths of the anti-Stokes beam which are induced by the stimulated Raman effect, these wavelengths λ_{AS} being necessarily lower than λ₁ due to the nature itself of this phenomenon.

Moreover, the device of the embodiment in FIG. 3 comprises an optional so-called downstream spectral filter SF′ arranged on the optical path of the anti-Stokes beam STK and adapted to filter the output beam co-propagating with the anti-Stokes beam having passed through the sample. The filter SF′ only transmits the anti-Stokes beam which is at wavelengths λ_{AS}=2πc/ω_{AS} less than λ₁. These wavelengths are the wavelengths which are relevant for the analysis of the sample Ech.

Structurally, the filters SF and SF′ are elements known to those skilled in the art and are color filters, for example, or each formed by a diffraction grating coupled to a deformable mirror or coupled to a spatial light modulator controllable for selecting the wavelengths to be transmitted or not.

In the device in FIG. 3, the anti-Stokes beam filtered by the filter SF′ is coupled—by means of a coupling assembly SCA comprising a focusing lens and a fiber coupler—into an optical detection fiber carrying the beam up to the photodetector Det. These elements allow for a greater stability of the device.

The device in FIG. 3 further comprises two optional mirrors M1, M2 for reasons of compactness and a collection objective CL (for example: NA˜0.5), to collimate the anti-Stokes beam, thus allowing for a large working distance for detection.

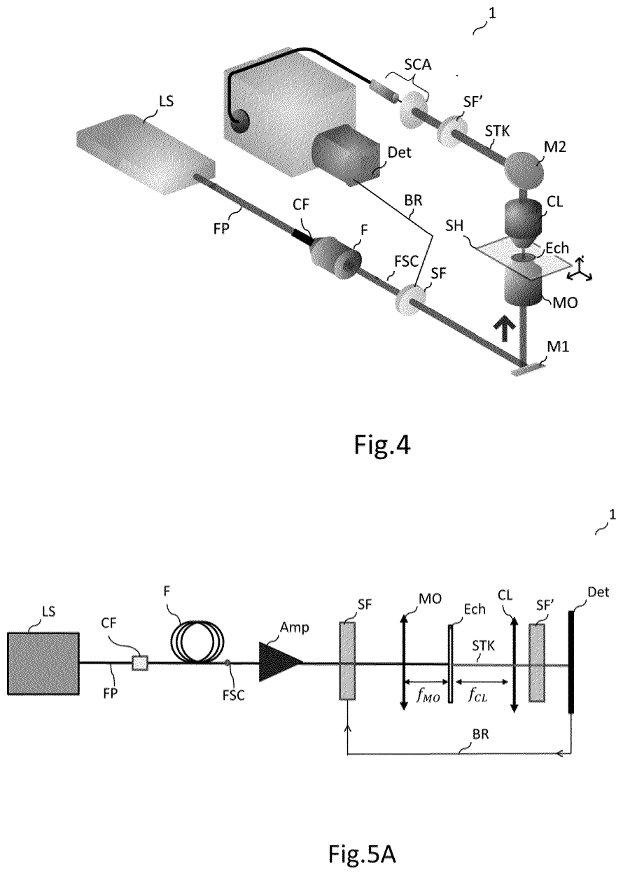

FIG. 4 shows an embodiment of the device in FIG. 3. In this embodiment, the upstream spectral filter is adaptive as a function of the detected anti-Stokes signal. To this end, the device 1 comprises a processor adapted to analyze frequency information of the anti-Stokes beam detected by the photodetector, typically via a spectrometer. Moreover, the upstream spectral filter SF is controllable and suitable for filtering, in addition to certain wavelengths less than λ₁, a spectral range of the output beam as a function of the frequency information analyzed by the processor. The control of the filter SF is done by means of a feedback loop BR.

According to a first variant, the filter SF of the device in FIG. 4 only transmits a spectral range relevant for the analysis of a predetermined sample Ech, in addition to the first wavelength. This allows for a faster analysis of the sample.

According to a second variant, the filter SF of the device in FIG. 4 allows improving the spectral resolution of the device. In theory, the spectral resolution of the device should be set by the spectral width of the pulse IL1, Δω₁. However, in particular because of the self-phase modulation contributing to the spectral broadening of the pulse IL1 at the outlet of fiber F, the resolution of the device is likely to be higher than Δω₁. In order to improve the spectral resolution, in addition to the wavelengths less than λ₁, the filter SF filters a range of wavelengths directly exceeding the wavelength λ₁ to reduce the spectral width of the pump beam, the latter setting the spectral resolution of the device. Note that the use of a filter SF without feedback control and filtering wavelengths directly exceeding the wavelength λ₁ to reduce the spectral width of the pump beam—in addition to wavelengths less than λ₁—is compatible with the embodiment in FIG. 3.

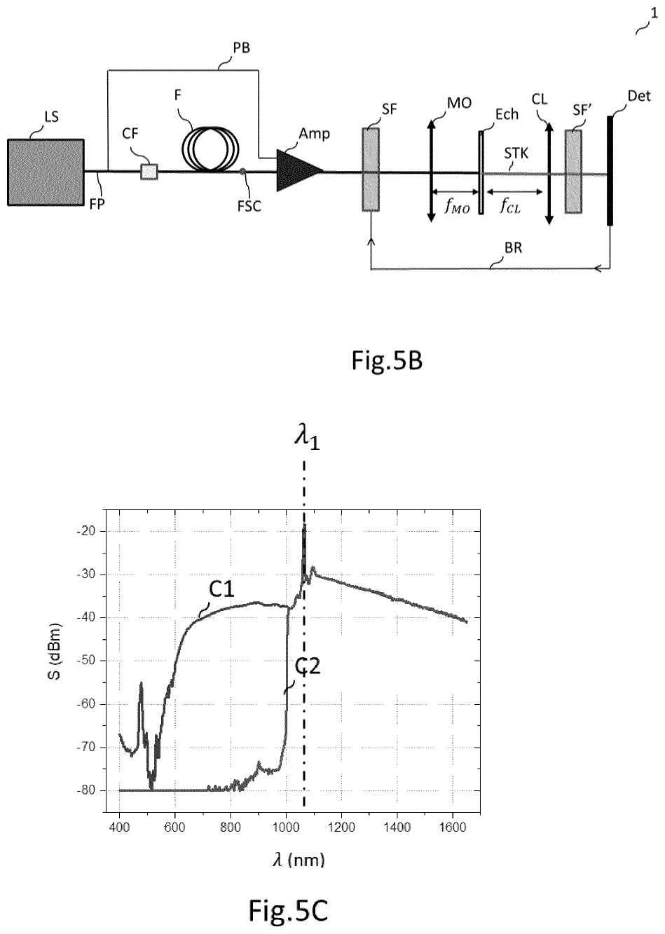

FIG. 5A diagrammatically shows an embodiment of the device in FIG. 4. In addition to the elements detailed in FIG. 4, the device in FIG. 5A comprises an amplifier Amp arranged on the optical path of the output beam upstream of the sample and adapted to selectively amplify the power of the output beam at the first wavelength λ₁. This embodiment allows partially or completely compensating for the decrease in power at wavelength λ₁ due to the generation of the supercontinuum and thus obtaining a more intense anti-Stokes signal. Note that the intensity I_{AS} of the anti-Stokes beam is proportional to I_{AS}∝N²·X_{Raman}⁽³⁾^{³}·I²_{ω}_{₁}·I_{ω}_{₂}, with I_{ω1·}I_{ω2} being the intensity of the beam FSC at λ₁ and at the second wavelength, respectively, N being the number of resonant molecules of the sample at the focus of the beam FSC, and X_{Raman}⁽³⁾ being the third-order Raman susceptibility of the sample molecule. The intensity of the beam FSC at λ₁ is thus essential for a good signal-to-noise ratio.

According to a preferred embodiment of the invention, denoted MP, the amplifier Amp comprises an amplifying fiber with a core doped with rare earth ions. In a manner known per se, this amplifying fiber is pumped to produce an inversion of the population of rare earth ions and thus, according to the principle of stimulated emission, to allow amplifying the output beam at the first wavelength. This amplifying fiber is attached or welded or coupled to a downstream end of the optical fiber F. In the output beam FSC, the power at the first wavelength λ₁ is too low to induce a supercontinuum in the amplifying fiber, the pump power is thus only used to “regenerate” or amplify the output beam, specifically at the first wavelength. Therefore, the doping element of the core is selected as a function of λ₁. For example, for λ₁=1064 nm, it is possible to use a fiber with a silica core doped with Nd3+ ions.

According to a first variant of the embodiment MP, the doped amplifying fiber is pumped by second wavelengths of the output beam which are lower than the first wavelength λ₁. This first variant is advantageous because it allows for an efficient use of the second wavelengths less than the first wavelength λ₁ which are undesirable for the detection of the anti-Stokes beam and which would be otherwise filtered by the filter SF. The implementation of such a device is very simple and consists in welding a piece of amplifying fiber (e.g., 50 cm) at the output of the non-linear fiber. Therefore, part of the power of pulses IL1 used to generate the second wavelengths less than λ₁ is “recycled” and allows for amplification of the beam FSC to λ₁.

For example, if the rare earth ion is erbium, the second wavelengths at about 980 nm allow pumping the amplifying fiber. If the rare earth ion is neodymium, second lengths between 730-760 nm and/or between 790-820 nm allow pumping the amplifying fiber. Therefore, for a laser source LS which is an Nd-YAG laser at λ₁=1064 nm, the aforementioned second wavelengths are lower than λ₁ and are recycled.

In the embodiments in which the laser source LS comprises at least one optical fiber with a core doped with rare earth ions, it is preferable to use the same ions as those allowing for the emission of the wavelength λ₁.

According to a second variant of the embodiment MP, shown in FIG. 5B, the amplifying fiber is pumped by a portion PB of the pump beam used to generate, by laser effect, the primary wavelength λ₁. This second variant is less advantageous than the first variant because it reduces the compactness of the device, but allows increasing the gain of the amplifier.

Alternatively, according to another embodiment different from the embodiment MP, the amplifier is not a doped optical amplifying fiber but a multi-pass amplifier of the regenerative type in a solid medium such as neodymium-doped YAG, or alexandrite, or titanium-doped sapphire.

According to different embodiments, the amplifier is pumped by second wavelengths of the output beam which are lower than the first wavelength λ₁, or by a portion PB of the primary beam of the source LS or pump lasers (not depicted in FIG. 5A). The choice of the solid amplifying medium is made as a function of the first wavelength so that the amplification is selective at this wavelength. For example, for λ₁=1064 nm, it is possible to use a crystal of Nd⁺³:YAG. This crystal produces a spectrally fine radiation and allows reshaping the beam width to λ₁ during amplification.

It is understood that the feedback loop BR and the filter SF′ are optional in the embodiment MP.

FIG. 5C is a depiction of the power spectral density of a pulse IL2 from the output beam FSC, at the outlet of fiber F (curve C1) and after filtering by the filter SF (curve C2), respectively. These curves are obtained without amplification. As a non-limiting example, the curves C1 and C2 are obtained for the device in FIG. 3, for pulses IL1 at a wavelength λ₁=1064 nm with a peak power of 10 kW and a pulse duration of 750 ps. The supercontinuum observed with the curve C1 is obtained in an undoped, microstructured, single-mode transverse fiber F with a rectangular index profile, with a wavelength λ_{ZDW} at 1000 nm and a core diameter of 4 pm. The curve C2 is obtained after filtering the second wavelengths less than 1000 nm. Note that, in the curves C1, the wavelengths less than λ₁ are mainly obtained by parametric four-wave mixing and the wavelengths exceeding λ₁ are obtained by soliton self-shift by Raman effect. This self-shift allows supplying the spectrum towards the high wavelengths while leaving part of the energy in place, thus creating a supercontinuum.

The curve C1 shows that the generation of the supercontinuum in the fiber F allows obtaining a beam FSC with a power at λ₁ which is not depleted and is sufficiently powerful to be used as a pump wave to obtain the stimulated Raman effect in the sample.

The curve C2 shows the effect of low-pass filtering which allows generating a filtered beam FSC which comprises almost no power at wavelengths less than 1000 nm, in particular where the CARS signature of the sample—via the anti-Stokes beam—will be present. Second wavelengths exceeding λ₁ are required to probe the chemical bonds of the sample Ech.

FIG. 6A shows the time profile of several spectral components of a laser pulse IL2 at the fiber F outlet. As a non-limiting example, these profiles are obtained for the device in FIG. 3, with a wavelength λ₁ equal to 1064 nm and the pulses IL1 have a duration of 750 ps and a peak power of 10 kW. These curves are obtained without amplification. The fiber F is an undoped microstructured single-mode fiber with a rectangular index profile, having a wavelength λ_{ZDW} and a 4 μm core diameter and a 2 m length. The curves 61-64 are vertically shifted for higher readability and are standardized to the same scale. The curve 61 corresponds to the time profile of the pulse IL2 at the wavelength λ₁. The curves 62, 63, and 64 correspond to the time profiles of pulses IL2 at wavelengths of λ₂=1200 nm, λ₂=1300 nm, and λ₂=1500 nm, respectively. Despite a slight time structuring due to non-linear effects during propagation in the fiber, the curve 61 clearly shows that the wavelength λ₁ is not depleted in the pulse IL2. Moreover, FIG. 6A shows the natural time synchronization of the different wavelengths λ₂ with the wavelength λ₁ in the beam FSC at the outlet of fiber F. This time synchronization is critical to obtain the stimulated Raman effect in the sample Ech and generate the anti-Stokes beam STK.

FIG. 6B shows the time profile of a laser pulse at 1064 nm of about 1.5 ns and peak power of 10 kW during the propagation thereof in a single-mode fiber of HI980 type with a silica core in a normal dispersion regime. In this fiber, the wavelength λ_{ZDW} is located at about 1300 nm. The curve 61′ corresponds to the profile of the initial pulse, the curve 62′ corresponds to the profile of the pulse at 1064 nm after propagation in 1 m of fiber, and the curve 63′ corresponds to the profile of the pulse at 1064 nm after propagation in 1.5 m of fiber. Specifically, as shown in the curve 63′, the central part of the pulse is almost completely depleted. These curves allow observing the depletion of the pump wavelength induced by stimulated Raman effect during propagation in the non-linear fiber, in normal dispersion regime.

The comparison of FIGS. 6A and 6B clearly shows that the Raman self-shift in abnormal dispersion regime depletes the central wavelength of the initial pulse significantly less than the stimulated Raman effect in normal dispersion regime for similar key parameters (fiber length, initial pulse power and duration).

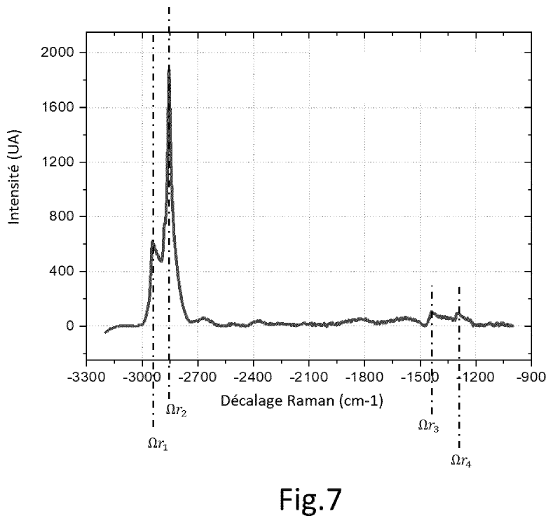

FIG. 7 shows the Raman shift Ω_{R} constructed from the spectrum of the anti-Stokes beam at ω_{AS}=Ω_{R}+ω₁ detected by the device of the invention for a paraffin sample. This spectrum is obtained with the following parameters: a primary power of 10 kW, a pulse IL1 with duration 750 ps, and a laser repetition frequency of 20 kHz. Specifically, the anti-Stokes beam includes 4 peaks at Raman frequencies Ω_{R1}=−2925 cm⁻¹, Ω_{R2}=−2830 cm⁻¹, Ω_{R3}=−1440 cm⁻¹, and Ω_{R4}=−1300 cm⁻¹. These peaks are features of the following modes: symmetric stretching CH₂, symmetric stretching CH₃, curvature CH₂, and torsion mode CH₂, respectively.

Therefore, FIG. 7 experimentally demonstrates the feasibility of multiplex CARS with the device of the invention, without using a delay line to synchronize a portion of the primary beam with the output beam on the sample Ech.

According to an advantageous embodiment of the invention, the optical fiber is adapted to have an additional zero-dispersion wavelength for a fundamental mode of the optical fiber, the additional zero-dispersion wavelength being separated by more than 3500 cm−1 from the first wavelength λ₁. This feature allows limiting the spectral width of the supercontinuum generated by the fiber at second wavelengths exceeding the first wavelength λ₁ which are relevant for the study of the sample, without needing to limit the length of the fiber. Indeed, for the fundamental mode, the self-shift by Raman effect is stopped when the soliton is shifted to a wavelength λ₂ equal to the additional zero-dispersion wavelength. Therefore, the additional zero-dispersion wavelength being separated by more than 3500 cm′¹ compared to the first wavelength λ₁ allows obtaining a supercontinuum which extends over 3500 cm′¹ from the first wavelength, for second wavelengths exceeding the first wavelength λ₁. Actually, In the wavelengths λ₂ exceeding λ₁ the width of the supercontinuum will be slightly higher than the separation between the additional zero-dispersion wavelength and λ₁ due to non-linear effects other than the self-shift by Raman effect.

1. A multiplex CARS microscopy device for analyzing a sample (Ech) comprising:
a laser source adapted to emit a primary beam having a first wavelength λ₁, in the form of pulses with a primary power;
an optical fiber having less than ten modes, said pulses propagating in the optical fiber in an abnormal dispersion regime to generate, from the primary beam, an output beam having a plurality of second wavelengths forming a supercontinuum, and said first wavelength λ₁, the second wavelengths being generated by non-linear conversion of the first wavelength λ₁;
an optical system adapted to focus the output beam onto said sample, so as to generate an anti-Stokes beam by stimulated Raman effect induced by at least one of the second wavelengths and the first wavelength λ₁ present in the output beam;
a photodetector adapted to detect the anti-Stokes beam.

2. The device according to claim 1, wherein the optical fiber is adapted so that a power of the output beam at the first wavelength λ₁ is higher than or equal to 10% of the primary power.

3. The device according to claim 1, wherein the optical fiber is a single-mode fiber with microstructured sheath.

4. The device according to claim 1, wherein the optical fiber has a zero-dispersion wavelength λ_{ZDW,i} associated with each i-th mode, said first wavelength being higher than all zero-dispersion wavelengths λ_{ZDW,i} by at least 10 nm.

5. The device according to claim 1, comprising an amplifier (Amp) arranged on an optical path of the output beam upstream of the sample and adapted to selectively amplify the power of the output beam at the first wavelength λ₁.

6. The device according to claim 5, wherein the amplifier comprises an amplifying fiber with a core doped with rare earth elements, said amplifying fiber being joined or welded or coupled to a downstream end of the optical fiber.

7. The device according to claim 6, wherein the amplifying fiber is pumped by second wavelengths of the output beam which are lower than the first wavelength λ₁.

8. The device according to claim 6, wherein the amplifying fiber is pumped by a portion of the primary beam.

9. The device according to claim 1, wherein said non-linear conversion includes self-shifting solitons generated by the propagation of each pulse within the optical fiber by Raman effect.

10. The device according to claim 1, comprising an upstream spectral filter (SF) arranged on an optical path of the output beam upstream of the sample and adapted to spectrally filter wavelengths less than the first wavelength.

11. The device according to claim 10, comprising a processor adapted to analyze frequency information of the anti-Stokes beam detected by the photodetector, the upstream spectral filter being controllable and adapted to additionally filter a spectral range of the output beam as a function of said frequency information.

12. The device according to claim 1, comprising a so-called downstream spectral filter arranged on an optical path of the anti-Stokes beam and adapted to filter the output beam co-propagating with the anti-Stokes beam.

13. The device according to claim 12, wherein the upstream filter is adapted to spectrally filter a range of wavelengths exceeding the first wavelength.

14. The device according to claim 1, wherein the optical fiber is adapted to have an additional zero-dispersion wavelength for a fundamental mode of the optical fiber, said additional zero-dispersion wavelength being separated by more than 3500 cm−1 from the first wavelength λ₁.

15. A multiplex CARS microscopy method for analyzing a sample with a device comprising an optical fiber having less than ten modes, said method comprising the following steps:
A. generating a primary having a first wavelength λ₁ in the form of pulses with a primary power;
B. generating, from the primary beam, an output beam having a plurality of second wavelengths forming a supercontinuum, and said first wavelength λ₁, the second wavelengths being generated by non-linear conversion of the first wavelength λ₁ in the optical fiber, said pulses propagating in the optical fiber in abnormal dispersion regime;
C. focusing the output beam onto said sample so as to generate an anti-Stokes beam by stimulated Raman effect induced by at least one of the second wavelengths and the first wavelength λ₁ present in the output beam;
D. detecting the anti-Stokes beam.

16. The device according to claim 1, wherein the optical fiber is adapted so that a power of the output beam at the first wavelength λ1 is higher than or equal to 20% of the primary power.
